(19) United States
(12) Patent Application Publication
(10) Pub. No.: US 2024/0346110 A1
(43) Pub. Date: Oct. 17, 2024

(54) INFORMATION PROCESSING APPARATUS, INFORMATION PROCESSING METHOD, AND PROGRAM

(71) Applicant: Nippon Telegraph and Telephone Corporation, Tokyo (JP)

(72) Inventors: Takaaki MORIYA, Musashino-shi, Tokyo (JP); Ai TSUNODA, Musashino-shi, Tokyo (JP); Manabu NISHIO, Musashino-shi, Tokyo (JP); Taizo YAMAMOTO, Musashino-shi, Tokyo (JP); Yu MIYOSHI, Musashino-shi, Tokyo (JP)

(21) Appl. No.: 18/683,170

(22) PCT Filed: Aug. 19, 2021
(86) PCT No.: PCT/JP2021/030386

§ 371 Date: Feb. 12, 2024

(51) Int. Cl. G06F 17/16

(52) U.S. Cl. CPC G06F 17/16

(57) ABSTRACT

An information processing device 1 includes an antecedence quantification unit 11 configured to obtain a scalar vᵢⱼ that quantifies a cross-correlation function between time-series data of items, a similarity calculation unit 12 configured to obtain a semantic similarity uᵢⱼ indicating semantic closeness between the items, and an unexpectedness calculation unit 13 configured to obtain unexpectedness of a combination of the items on the basis of a position of a point indicating the combination of the items on a plane having the scalar vᵢⱼ and the semantic similarity uᵢⱼ as axes.

### TECHNICAL FIELD

The present invention relates to an information processing device, an information processing method, and a program.

### BACKGROUND ART

One of the roles of data science is to extract business intelligence from data. In order to enable a data scientist to make a better proposal to a customer, it is required to support the data scientist in obtaining a wide range of knowledge. That is, a method of obtaining objective evidence that a data scientist could not have intuitively through of from data and enabling derivation of unexpected business intelligence is anticipated.

### CITATION LIST

### Patent Literature

Patent Literature 1: Japanese Patent No. 6620950

### SUMMARY OF INVENTION

### Technical Problem

For example, electricity rates tend to increase or decrease in price several months after increases or decreases in gasoline price. Although such a relationship between electricity rates and gasoline prices is obvious, there is a possibility that an antecedent relationship is hidden among items that are not obvious, that is, items that are distant in meaning. Finding an unexpected antecedent relationship that could not have been thought of or would have been difficult to find by a person can be expected to be utilized for making unexpected co-selling plans and pricing strategies.

A cross-correlation function (CCF) is a method of representing an antecedent relationship between time-series variables. In Patent Literature 1, cross-correlation is used for learning of word vectors from past data to be analyzed, but it does not find an unexpected antecedent relationship that could not have been thought of or would have been difficult to find by a person. That is, dissimilar things such as a time series and the meaning of a word are not considered at the same time.

The present invention has been made in view of the above, and an object of the present invention is to extract combinations of items that unexpectedly have an antecedent relationship in time series.

### Solution to Problem

An information processing device of an aspect of the present invention includes: an antecedence quantification unit configured to obtain a scalar that quantifies a cross-correlation function between time-series data of items; a similarity calculation unit configured to obtain a semantic similarity indicating semantic closeness between the items; and an unexpectedness calculation unit configured to obtain unexpectedness of a combination of the items on the basis of a position of a point indicating the combination of the items on a plane having the scalar and the semantic similarity as axes.

An information processing method of an aspect of the present invention includes: by a computer, obtaining a scalar that quantifies a cross-correlation function between time-series data of items; obtaining semantic similarity indicating semantic closeness between the items; and obtaining unexpectedness of a combination of the items on the basis of a position of a point indicating the combination of the items on a plane having the scalar and the semantic similarity as axes.

### Advantageous Effects of Invention

According to the present invention, it is possible to extract combinations of items that unexpectedly have an antecedent relationship in time series.

### BRIEF DESCRIPTION OF DRAWINGS

FIG. 1 is a functional block diagram illustrating an example of a configuration of an information processing device of the present embodiment.

FIG. 2 is a flowchart illustrating an example of a flow of processing of the information processing device.

FIG. 3 is a diagram illustrating an example of time-series data.

FIG. 4 is a diagram in which time-series data is plotted on a plane when a lag is −2.

FIG. 5 is a diagram illustrating an example of an obtained cross-correlation function.

FIG. 6 is a diagram in which correlation strength and semantic similarity are plotted on a plane.

FIG. 7 is a diagram illustrating an example of obtaining unexpectedness using an inner product of vectors.

FIG. 8 is a diagram illustrating an example of a hardware configuration of the information processing device.

### DESCRIPTION OF EMBODIMENTS

Hereinafter, an embodiment of the present invention will be described using the drawings.

### Configuration of Information Processing Device

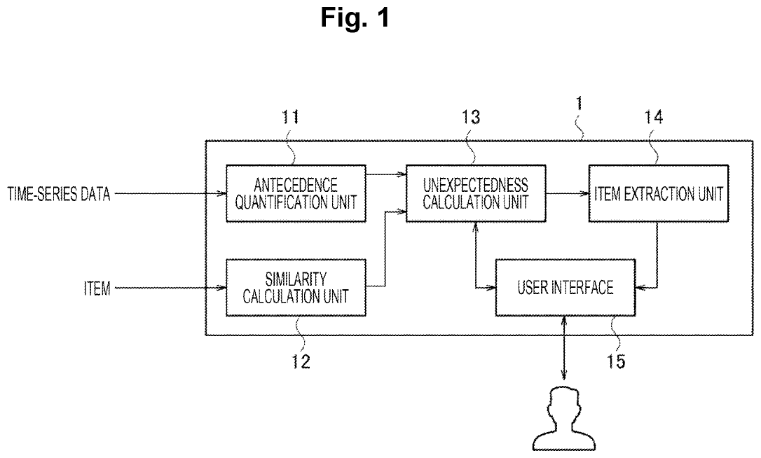

An example of a configuration of an information processing device of the present embodiment will be described with reference to FIG. 1. The information processing device 1 is a device that extracts an item that moves proactively even if the meaning is distant from a large number of items. The information processing device 1 includes an antecedence quantification unit 11, a similarity calculation unit 12, an unexpectedness calculation unit 13, an item extraction unit 14, and a user interface 15.

The antecedence quantification unit 11 obtains a scalar (representative value) that quantifies antecedence between time-series data of items. More specifically, the antecedence quantification unit 11 obtains a cross-correlation function of time-series data x and y of items i and j, and obtains a representative value vᵢⱼ of the obtained cross-correlation function. The representative value vᵢⱼ is an arbitrary statistic of the cross-correlation function, and represents the correlation strength between the items i and j. Hereinafter, the representative value vᵢⱼ may be referred to as a scalar vᵢⱼ or a correlation strength vᵢⱼ.

The similarity calculation unit 12 obtains semantic closeness (semantic similarity) between items. More specifically, the similarity calculation unit 12 obtains semantic vectors of the items i and j, obtains a cosine similarity of the obtained semantic vectors, and sets the cosine similarity as a semantic similarity uᵢⱼ between the items i and j.

The unexpectedness calculation unit 13 obtains unexpectedness between the items from the correlation strength between the items and the semantic similarity. More specifically, the unexpectedness calculation unit 13 plots a point (uᵢⱼ, vᵢⱼ) indicating the items i and j represented by the correlation strength vᵢⱼ and the semantic similarity uᵢⱼ between the items i and j on a plane having the correlation strength and the semantic similarity as axes, and obtains unexpectedness rᵢⱼ between the items i and j on the basis of the position of the point (uᵢⱼ, vᵢⱼ) on the plane. For example, the unexpectedness calculation unit 13 obtains the unexpectedness rᵢⱼ between the items i and j on the basis of a distance from the center point μ (μᵤ, μᵥ) of a group to the point (uᵢⱼ, vᵢⱼ). The group is a collection of points obtained by plotting correlation strengths and semantic similarities between a large number of items. In the present embodiment, for each of N combinations of items, the correlation strength vᵢⱼ and the semantic similarity uᵢⱼ between the items i and j are obtained, and a point (uᵢⱼ, vᵢⱼ) indicating a combination of the item i and the item j is plotted on a plane. 1≤ i and j≤N are satisfied. Since a longer distance from the center of the group should indicate greater unexpectedness, the unexpectedness calculation unit 13 increases the unexpectedness as the distance from the center point increases.

The unexpectedness calculation unit 13 may filter the unexpectedness on the basis of a direction from the origin (0, 0) or the center point μ (μᵤ, μᵥ) of the group. For example, the unexpectedness calculation unit 13 extracts only points where the correlation strength is in the positive direction and semantic similarity is in the negative direction from a reference point.

The item extraction unit 14 calculates a score based on unexpectedness with respect to each other item for each item, and extracts an item having a high score.

The user interface 15 includes a display means and an input means and provides an interface to a user. For example, the user interface 15 presents unexpectedness calculated by the unexpectedness calculation unit 13 to the user, receives selection of a method of obtaining unexpectedness from the user, displays a score calculated by the item extraction unit 14, or displays information on an item extracted by the item extraction unit 14.

### Operation of Information Processing Device

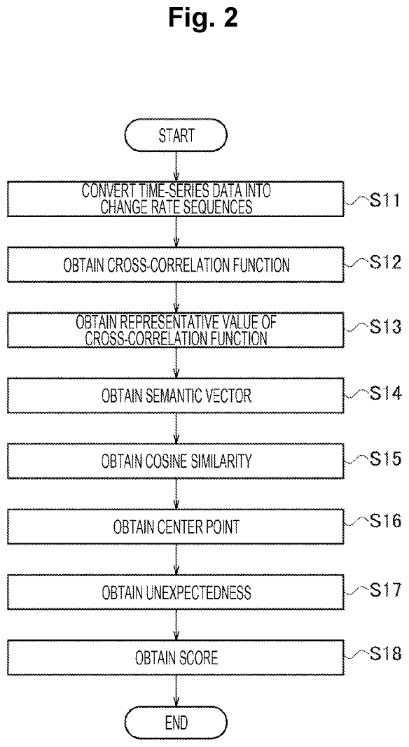

Next, an example of a flow of processing of the information processing device 1 of the present embodiment will be described with reference to the flowchart in FIG. 2.

In step S11, the antecedence quantification unit 11 converts time-series data x of the item i and time-series data y of the item j into change rate sequences x′ and y′. Time-series data is a predetermined type of data of an item that varies along a time axis. Time-series data is, for example, an economic index including a price. An economic index is often a unit root process, and there is a problem that if the unit root processes are regressed, a false regression occurs. To avoid this, the antecedence quantification unit 11 converts the original sequences x and y into change rate sequences x′ₜ=(xₜ−xₜ₋₁)/xₜ₋₁ and y′ₜ=(yₜ−yₜ₋₁)/yₜ₋₁. Alternatively, the antecedence quantification unit 11 converts the original sequences x and y into differential sequences Δxₜ=xₜ−xₜ₋₁ and Δyₜ=yₜ−yₜ₋₁ instead of change rate sequences. By considering the time-series data as a change rate (difference) in this manner, it is possible to detect an item in which similar change occurs. Note that the antecedence quantification unit 11 may proceed to step S12 using the time-series data x and y that is the original sequences as they are without performing processing of step S11. The time-series data may be an index other than the economic index. Hereinafter, it is assumed that the time-series data x and y is any one of the original sequences x and y, the change rate sequences x′ and y′, and difference sequences Δx and Δy.

In step S12, the antecedence quantification unit 11 obtains a cross-correlation function between the time-series data x and the time-series data y. The cross-correlation function R_{xy}(k) is obtained by following Formula (1).

$$\begin{matrix}[ Math . 1 ] & \\ {R}_{xy ( k )} = C or ( {x}_{t} , {y}_{t + k} ) = \frac{\sum ( {x}_{t} - \overline{x} ) ( {y}_{t + k} - \overline{y} )}{\sqrt{\sum {( {x}_{t} - \overline{x} )}^{2}} \sqrt{\sum {( {y}_{t} - \overline{y} )}^{2}}} & ( 1 )\end{matrix}$$

The cross-correlation function R_{xy}(k) is a correlation coefficient between the time-series data x and the time-series data y when the time-series data y is shifted by a time k. −1≤R_{xy}(k)≤1 is satisfied. Unlike dynamic time warping (DTW), the cross-correlation function represents antecedence and lagging, and thus is directly linked to predictability of time series. Therefore, the cross-correlation function can also extract the time-series data y that considerably precedes the time-series data x (when k is negative and small, R_{xy}(k) is large).

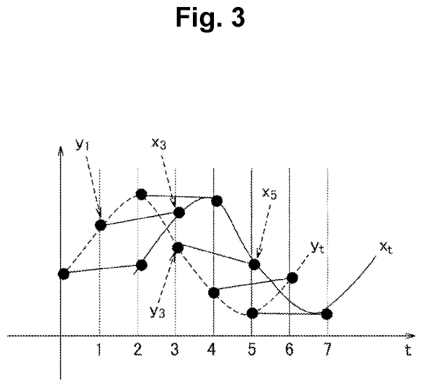

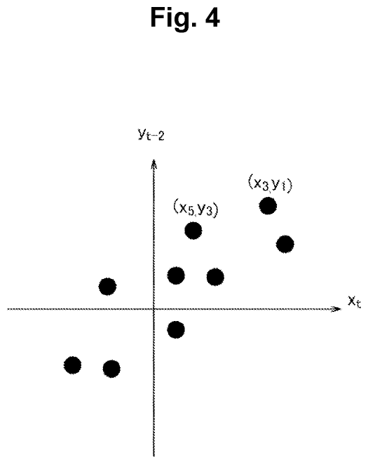

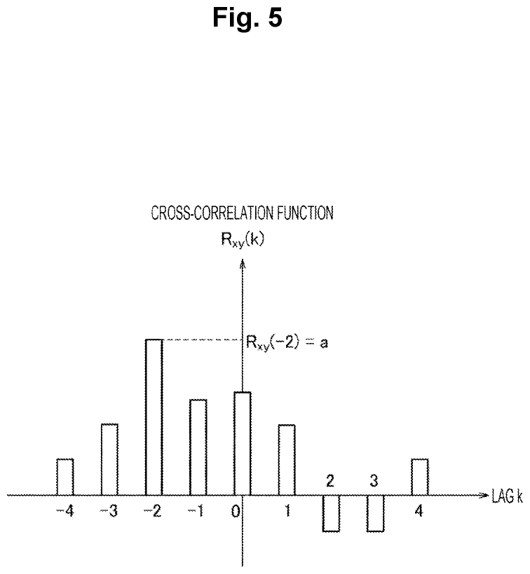

Here, calculation of the cross-correlation function R_{xy}(k) will be described with reference to FIGS. 3 to 5. Solid lines in FIG. 3 represent the time-series data x, and broken lines represent the time-series data y. At the time of obtaining a cross-correlation function R_{xy}(−2) in the case of lag k=−2, a point (xₜ, yₜ₋₂) represented by xₜ at a time t and yₜ₋₂ at a time t−2 is plotted on a plane as illustrated in FIG. 4. That is, points (x₃, y₁), (x₄, y₂), (x₅, y₂) . . . are plotted. A correlation coefficient a between xₜ and yₜ₋₂ is obtained by following Formula (2).

$$\begin{matrix}[ Math . 2 ] & \\ a = \frac{\sum ( {x}_{t} - \overline{x} ) ( {y}_{t - 2} - \overline{y} )}{\sqrt{\sum {( {x}_{t} - \overline{x} )}^{2}} \sqrt{\sum {( {y}_{t - 2} - \overline{y} )}^{2}}} & ( 2 )\end{matrix}$$

where x (with bar above) is the mean of x and y (with bar above) is the mean of yₜ₋₂. The obtained correlation coefficient a is the cross-correlation function R_{xy}(−2)=a when lag k=−2. By changing the value of k and obtaining a correlation coefficient for each k, the cross-correlation function R_{xy}(k) is obtained as illustrated in FIG. 5.

In step S13, the antecedence quantification unit 11 obtains a representative value of the cross-correlation function. Since the cross-correlation function is a function of the lag k, an arbitrary statistic of the values of the cross-correlation function in a predetermined section (−L≤k≤+L) represented by any one of following Formulas (3) to (6) is calculated and set as a representative value vᵢⱼ of the cross-correlation function.

$$\begin{matrix}[ Math . 3 ] & \\ {v}_{ij} = \frac{1}{2 L + 1} {\sum }_{k = - L}^{+ L} {R}_{xy} ( k ) & ( 3 )\end{matrix}$$

$${v}_{ij} = max ( {R}_{xy} ( k ) ) \qquad ( 4 )$$

$${ν}_{ij} = {σ}_{xy} = \sqrt{E \{ {( {R}_{xy} ( k ) - μ )}^{2} \}} \qquad ( 5 )$$

$${v}_{ij} = {α}_{xy} = \frac{{E ( {R}_{xy} ( k ) - μ )}^{4}}{{σ}_{xy}^{4}} \qquad ( 6 )$$

Formula (3) represents an average value with respect to −L≤k≤+L of Rxy(k). Formula (4) represents a maximum value with respect to −L≤k≤+L of Rxy(k). These average value and maximum value can be regarded as simple representative values of the relationship between the time-series data x and the time-series data y.

Formula (5) represents a standard deviation with respect to −L≤k≤+L of Rxy(k). A small standard deviation indicates a high correlation at a particular lag. That is, if the time-series data y is shifted by k, it is possible to capture data having a form substantially matching the time-series data x. On the other hand, a relatively large standard deviation indicates that both the time-series data x and the time-series data y have waveforms moving at similar cycles.

Formula (6) represents a kurtosis with respect to −L≤k≤+L of Rxy(k). A high kurtosis indicates a high correlation at a particular lag k. That is, if the time-series data y is shifted by k, it is possible to capture data having a form substantially matching the time-series data x.

A statistic other than the above may be used as a representative value.

In step S14, the similarity calculation unit 12 obtains a semantic vector (distributed representation) of an item. For example, the similarity calculation unit 12 obtains semantic vectors of the items i and j using Word2vec or an ontology.

In step S15, the similarity calculation unit 12 obtains a similarity of the semantic vectors between the items, and sets the similarity as a semantic similarity between the items. That is, the similarity uᵢⱼ of the items i and j is obtained as a cosine similarity in following Formula (7). In addition to the cosine similarity, an index indicating a distance or similarity can be used as uᵢⱼ.

$$\begin{matrix}[ Math . 4 ] & \\ {u}_{ij} = \frac{\vec{P} \cdot \vec{Q}}{\vert \vec{P} \vert \vert \vec{Q} \vert} & ( 7 )\end{matrix}$$

where P (with “→” above) is the semantic vector of the item i and Q (with “→” above) is the semantic vector of the item j.

The antecedence quantification unit 11 and the similarity calculation unit 12 perform processing up to step S15 described above for each combination of the N items to obtain the correlation strength vᵢⱼ and the semantic similarity uᵢⱼ.

In step S16, the unexpectedness calculation unit 13 obtains the center point of the group. The center point μ (μᵤ, μᵥ) of the group is obtained by following Formula (8).

$$\begin{matrix}[ Math . 5 ] & \\ {μ}_{u} = \frac{1}{{N}^{2}} {\sum }_{i = 1}^{N} {\sum }_{j = 1}^{N} {u}_{ij} , {μ}_{v} = \frac{1}{{N}^{2}} {\sum }_{i = 1}^{N} {\sum }_{j = 1}^{N} {v}_{ij} & ( 8 )\end{matrix}$$

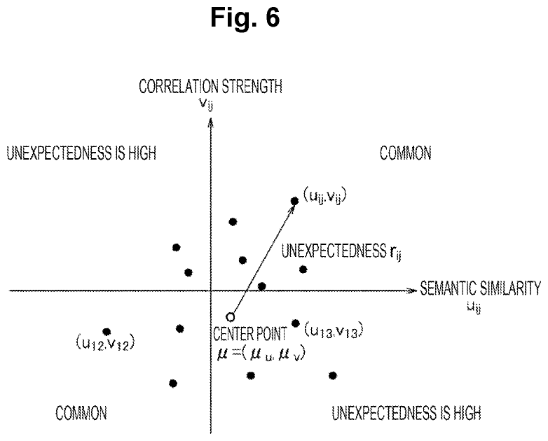

FIG. 6 is a diagram in which the horizontal axis represents the semantic similarity, the vertical axis represents the correlation strength, the correlation strength and the semantic similarity of each of sets of items are plotted on a plane, and the center point is obtained.

In step S17, the unexpectedness calculation unit 13 obtains unexpectedness of a set of items on the basis of distances from the center point. The unexpectedness calculation unit 13 obtains a Euclidean distance or a Mahalanobis distance between a point (uᵢⱼ, vᵢⱼ) obtained by plotting the correlation strength and the semantic similarity of the items i and j and the center point μ (μᵤ, μᵥ) of the group, and sets the Euclidean distance or the Mahalanobis distance as an unexpectedness rᵢⱼ of the items i and j.

The Euclidean distance is obtained by following Formula (9).

$$\begin{matrix}[ Math . 6 ] & \\ {r}_{ij} = \sqrt{{( {u}_{ij} - {μ}_{u} )}^{2} + {( {v}_{ij} - {μ}_{v} )}^{2}} & ( 9 )\end{matrix}$$

The Mahalanobis distance is obtained by following Formula (10).

$$\begin{matrix}[ Math . 7 ] & \\ {r}_{ij} = \sqrt{{( {x}_{ij} - μ )}^{T} {\sum }^{- 1} ( {x}_{ij} - μ )} & ( 10 )\end{matrix}$$

where xᵢⱼ, μ, and Σ are defined as below

$${x}_{ij} = ( \begin{matrix}{u}_{ij} \\ {v}_{ij}\end{matrix} ) , μ = ( \begin{matrix}{μ}_{u} \\ {μ}_{v}\end{matrix} ) , \sum = ( \begin{matrix}{σ}_{i}^{2} & {σ}_{ij} \\ {σ}_{ji} & {σ}_{j}^{2}\end{matrix} )$$

As described above, a set of items deviating from the center of a group can be extracted as having a high unexpectedness. In a case where only a set of items that are different in meaning but are antecedent indexes is extracted therefrom, the unexpectedness calculation unit 13 may apply a filter to extract only the upper left quadrant from the origin (uᵢⱼ<0 & vᵢⱼ>0) or the upper left quadrant from the center point ((uᵢⱼ−μᵤ)/σᵤ<0 & (vᵢⱼ−μᵥ)/σᵥ). The upper right quadrant is a region having similar meanings and also having a time-series correlation, and the lower left quadrant is a region having not similar meanings and also having no time-series correlation. A set of items belonging to either of both is a common combination. On the other hand, the lower right quadrant is a region having similar meanings but having no time-series correlation, and the upper left quadrant is a region having not similar meanings but having a time-series correlation. A set of items belonging to either of both is a combination having a high unexpectedness. By filtering a set of items belonging to the upper left quadrant, combinations that are not similar in meaning but have a time-series correlation can be extracted.

Note that, in a case where the representative value vᵢⱼ of the cross-correlation function is obtained using Formula (3) or Formula (4), since −1<uᵢⱼ≤1 and −1≤vᵢⱼ≤1 are satisfied by definition, preprocessing such as normalization or standardization is unnecessary, and thus the shape of the group is not distorted and versatility is high.

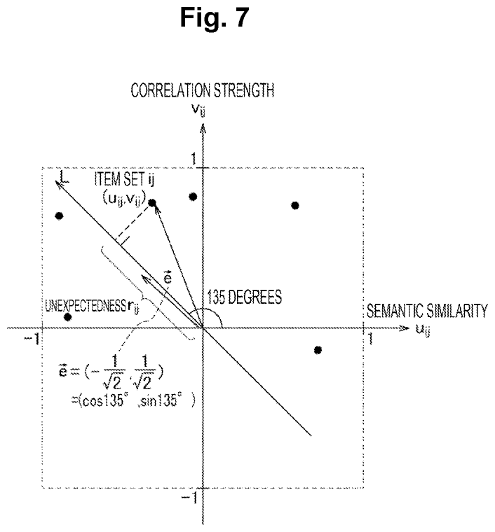

In addition to the Euclidean distance and the Mahalanobis distance calculated above, the unexpectedness calculation unit 13 may obtain a component in the upper left direction of 45 degrees from the origin as an unexpectedness, as illustrated in FIG. 7. Specifically, the inner product of the unit vector e (with “→” above)=(−1/√2, 1/√2) in the upper left direction and the vector (uᵢⱼ, vᵢⱼ) from the origin to the set of the items i and j is set as the unexpectedness rᵢⱼ of the items i and j. Basically, −1 ≤uᵢⱼ≤1 and −1<vᵢⱼ≤1 are assumed.

In the example of FIG. 7, the unit vector e (with “→” above) is a vector of upper left 45 degrees starting from the origin, but the unit vector e (with “→” above) may be a vector of an angle e starting from an arbitrary point (X, Y), for example, the center point of the group. The angle θ may be arbitrarily set by the user.

Upon completion of processing up to step S17, the user interface 15 may present a screen in which the correlation strength and the semantic similarity of each of the sets of items are plotted on a plane to the user. Both the unexpectedness obtained using the Euclidean distance and the unexpectedness obtained using the Mahalanobis distance may be presented to the user, and selection of an unexpectedness used in the item extraction unit 14 may be received from the user.

In step S18, the item extraction unit 14 calculates a score of each item on the basis of unexpectedness and extracts an item having a high score. The score Sᵢ of the item i is obtained using following Formula (11). In addition, an item A having the highest score is extracted using Formula (12).

$$\begin{matrix}[ Math . 8 ] & \\ {S}_{i} = {\sum }_{j} {r}_{ij} & ( 11 )\end{matrix}$$

$$A = {arg max {S}_{i}}_{i} \qquad ( 12 )$$

By referring to the score Sᵢ, the user can ascertain an item that is an antecedent index of many items even if the meaning is distant.

As described above, the information processing device 1 of the present embodiment includes the antecedence quantification unit 11 configured to obtain a scalar vᵢⱼ that quantifies a cross-correlation function between time-series data of items, the similarity calculation unit 12 configured to obtain a semantic similarity uᵢⱼ indicating semantic closeness between the items, and the unexpectedness calculation unit 13 configured to obtain unexpectedness of a combination of the items on the basis of positions of points indicating combinations of the items on a plane having the scalar vᵢⱼ and the semantic similarity uᵢⱼ as axes. In the present embodiment, by representing a function called a cross-correlation function by a scalar, synthesis of heterogeneous data such as time-series data of an item and the meaning of the item can be simply and rapidly executed, and an item that proactively moves can be detected even if the meaning thereof is distant.

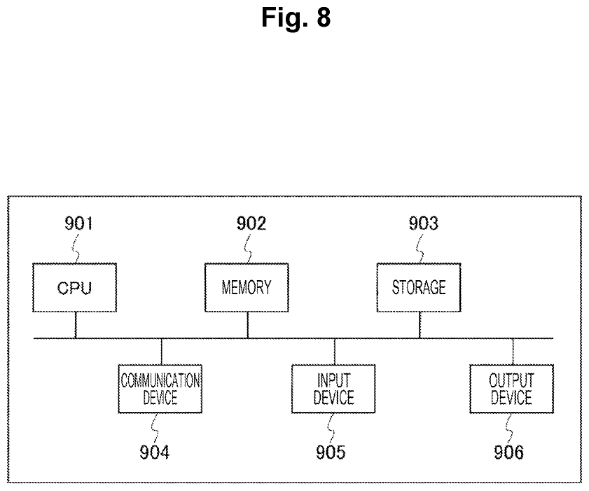

For example, as illustrated in FIG. 8, a general-purpose computer system including a central processing unit (CPU) 901, a memory 902, a storage 903, a communication device 904, an input device 905, and an output device 906 can be used as the information processing device 1 described above. In this computer system, the information processing device 1 is realized by the CPU 901 executing a predetermined program loaded on the memory 902. This program can be recorded on a computer-readable recording medium such as a magnetic disk, an optical disc, or a semiconductor memory, or can be distributed via a network.

### REFERENCE SIGNS LIST

1 Information processing device
11 Antecedence quantification unit
12 Similarity calculation unit
13 Unexpectedness calculation unit
14 Item extraction unit
15 User interface

1. An information processing device comprising one or more processors configured to perform operations comprising:
obtaining a scalar that quantifies a cross-correlation function between time-series data of items;
obtaining a semantic similarity indicating semantic closeness between the items; and
obtaining obtain unexpectedness of a combination of the items on the basis of a position of a point indicating the combination of the items on a plane having the scalar and the semantic similarity as axes.

2. The information processing device according to claim 1, wherein the operations comprise:
obtaining a Euclidean distance or a Mahalanobis distance from a predetermined reference position to the point indicating the combination of the items, or a component in an arbitrary direction from a predetermined reference position, and setting the obtained distance or component as unexpectedness of the combination of the items.

3. The information processing device according to claim 1, wherein the operations comprise:
obtaining a score based on the unexpectedness for each item to extract an item.

4. The information processing device according to claim 1, wherein the operations comprise:
converting the time-series data into a change rate sequence or a difference sequence to obtain the scalar.

5. An information processing method comprising:
by a computer,
obtaining a scalar that quantifies a cross-correlation function between time-series data of items;
obtaining a semantic similarity indicating semantic closeness between the items; and
obtaining unexpectedness of a combination of the items on the basis of a position of a point indicating the combination of the items on a plane having the scalar and the semantic similarity as axes.

6. A non-transitory computer readable medium storing one or more instructions causing a computer to execute:
obtaining a scalar that quantifies a cross-correlation function between time-series data of items;
obtaining a semantic similarity indicating semantic closeness between the items; and
obtaining unexpectedness of a combination of the items on the basis of a position of a point indicating the combination of the items on a plane having the scalar and the semantic similarity as axes.
